(19) United States
(12) Patent Application Publication
(10) Pub. No.: US 2004/0098843 A1
(43) Pub. Date: May 27, 2004

(54) Tube clamp

(76) Inventor: Dian-Tai Chen, Taichung County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/302,889

(22) Filed: Nov. 25, 2002

(51) Int. Cl. F16L 33/08

(52) U.S. Cl. 24/274 R; 24/274 P

(57) ABSTRACT

A tube clamp for fastening a hose to a hard tube is constructed to include a binding strap having a lead end and a tail end, and a screw holder with two clamping plates for fastening to the binding strap to join the ends of the binding strap and fastening up the binding strap on the tubes to be connected, the binding strap having two vertical stop portions stopped at two sides of the clamping plates of the screw holder to prohibit the clamping plates from horizontal displacement, and two protruded portions respectively engaged into respective retaining holes in the clamping plates of the screw holder to stop the clamping plates from vertical displacement.

### BACKGROUND OF THE INVENTION

1. Field of the Invention

The present invention relates to a tube clamp adapted to fasten a hose or the like to a hard tube and, more particularly, to such a tube clamp, which is durable in use.

2. Description of the Related Art

FIGS. 1A and 1B show a tube clamp according to the prior art. This structure of tube clamp comprises a transversely grooved metal binding strap 1, which has an opening 2 at its one end, namely, the lead end, top and bottom notches L in the lead end above and below the opening 2, and four protruded stop portions 7 at two ends of each of the notches L, a screw holder 3 fastened to the lead end of the binding strap 1 by its integrated clamping plates 4, and a screw 6 mounted in the screw holder 3 and turned to move the tail end of the binding strap 1 over its lead end in tightening up the tube clamp. The screw 6 has threads meshed with transverse grooves of the binding strap 1. The clamping plates 4 have and protruded engagement portions 5 fastened to the periphery of the opening 2. This structure of tube clamp is not satisfactory in function. One drawback of this structure of tube clamp is that the clamping plates 4 of the screw holder 3 tend to be forced away from the binding strap 1 when the tube clamp excessively tightened (see FIG. 1C). Another drawback of this structure of tube clamp is that the formation of the transverse grooves of the binding strap 1 weakens the structural strength of the binding strap 1. Still another drawback of this structure of tube clamp is that the screw 6 tends to be disengaged from the transverse grooves of the binding strap 1 when the tube clamp excessively tightened.

FIGS. 2, 3A, and 3B show another structure of tube clamp according to the prior art. According to this design, the tube clamp comprises a transversely grooved binding strap 10, a screw holder 20, and a screw 24. The binding strap 10 has a through hole 11 in the lead end, two recessed portions 12 in the lead end at two opposite lateral sides of the through hole 11, and two lugs 13 respectively protruded from the top and bottom sides of the lead end in reversed directions. The screw holder 20 comprises two clamping plates 21 respectively clamped on the back sidewall of the lead end of the binding strap 10. The clamping plates 21 each have a retaining hole 23 forced into engagement with one lug 13 of the binding strap 10, and two protruded engagement portions 22 respectively forced into engagement with the recessed portions 12 of the binding strap 10.

### SUMMARY OF THE INVENTION

It is one object of the present invention to provide a tube clamp, which is durable in use. It is another object of the present invention to provide a tube clamp, which is practical in use. According to the present invention, the tube clamp comprises a binding strap, and a screw holder with two clamping plates for fastening to the binding strap to join the ends of the binding strap and fastening up the binding strap on the tubes to be connected. The clamping plates each have a retaining hole. The binding strap has two vertical stop portions stopped at two sides of the clamping plates of the screw holder to prohibit the clamping plates from horizontal displacement, two lugs respectively inserted through the retaining holes of the clamping plates and clamped on the outside wall of the screw holder to secure the screw holder to the lead end of the binding strap, and two protruded portions respectively engaged into the retaining holes of the clamping plates of the screw holder to stop the clamping plates from vertical displacement.

### BRIEF DESCRIPTION OF THE DRAWINGS

FIG. 1 is an exploded view of a tube clamp constructed according to the prior art.

FIG. 1B is an elevational assembly view in an enlarged scale of a part of the tube clamp shown on FIG. 1.

FIG. 1C is a schematic sectional view of the tube clamp of FIG. 1B, showing the clamping plates of the screw holder disengaged from the binding strap.

FIG. 2 is an exploded view of another structure of tube clamp constructed according to the prior art.

FIG. 3A is an elevational assembly view in an enlarged scale of a part of the tube clamp of FIG. 2.

FIG. 3B is a schematic sectional view of the tube clamp shown in FIG. 3A, showing the screw rotated.

FIG. 4 is an exploded view of a tube clamp constructed according to the present invention.

FIG. 4A is an extended out view of the lead end of the binding strap of the tube clamp according to the present invention.

FIG. 4B is an enlarged view of a part of FIG. 4A.

FIG. 5 is a sectional assembly view of a part of the tube clamp according to the present invention.

FIG. 6 is a sectional view taken along line A-A of FIG. 5.

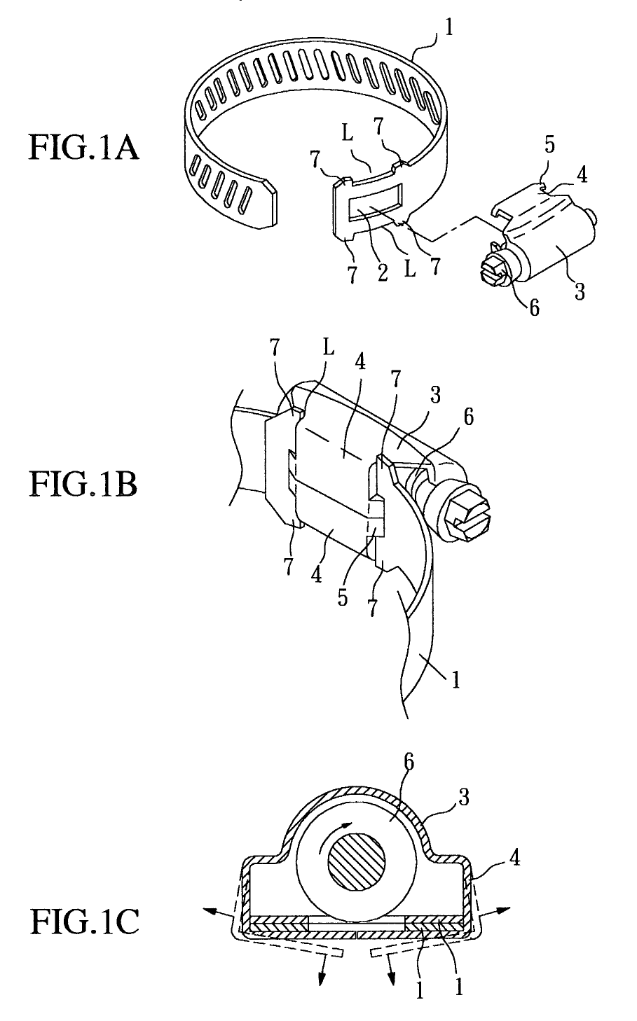

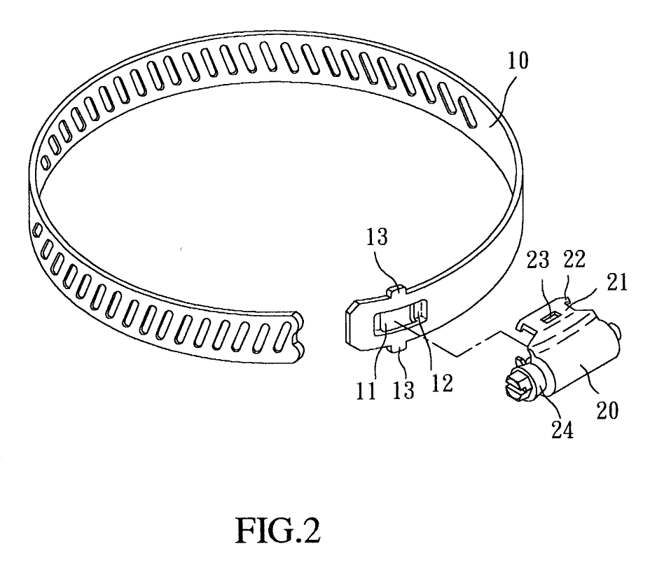

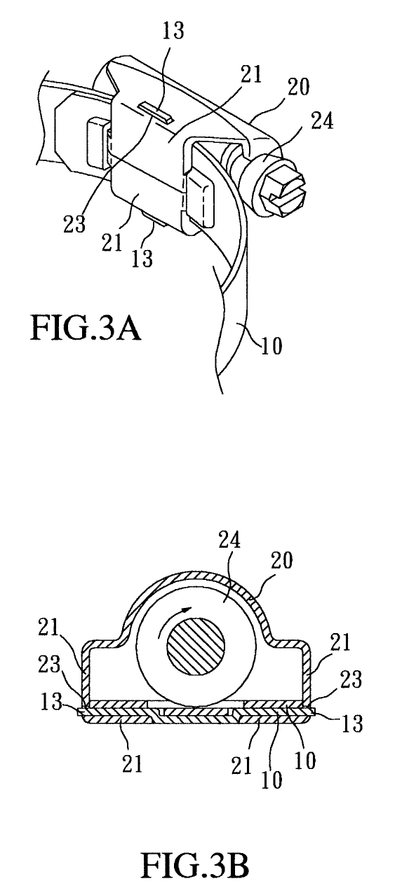

### DETAILED DESCRIPTION OF THE PREFERRED EMBODIMENT

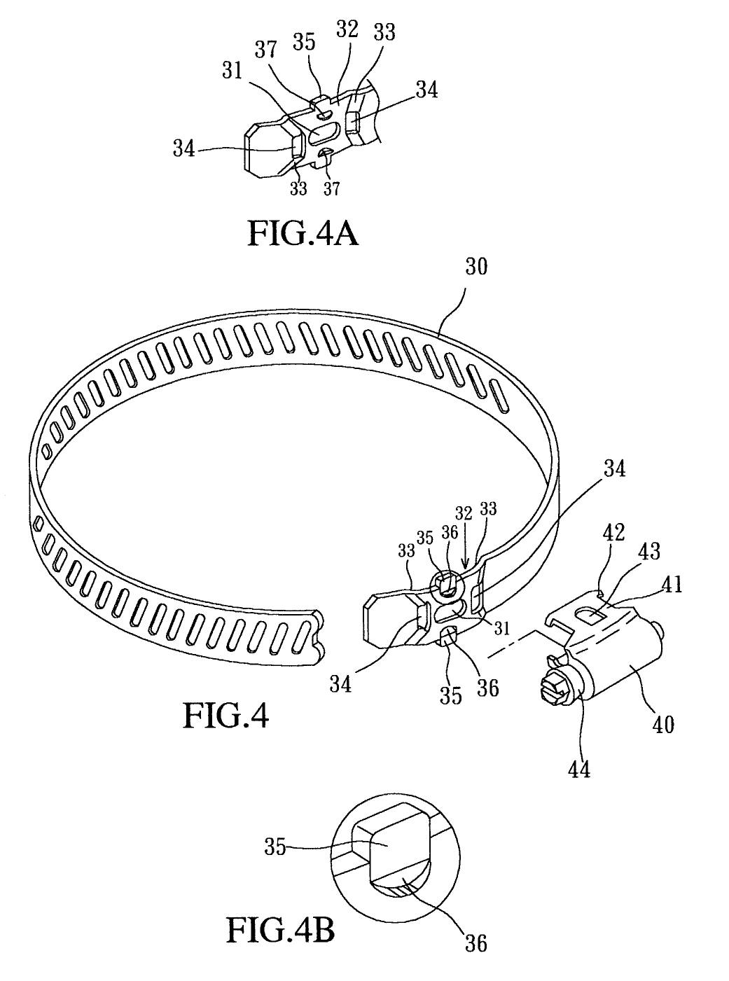

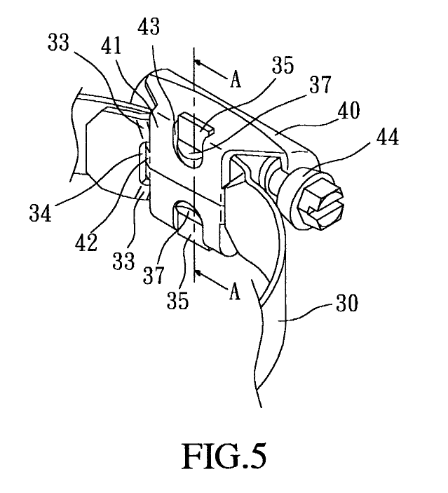

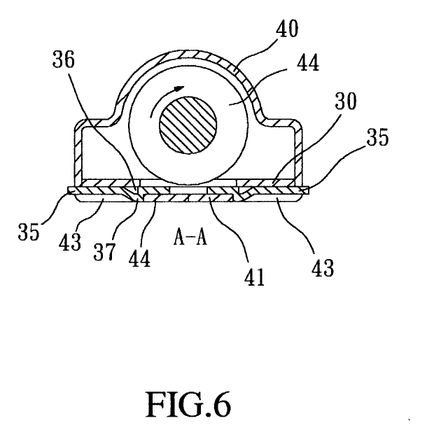

Referring to FIGS. 4, 4A, 4B, 5, and 6, a tube clamp in accordance with the present invention is shown comprised of a binding strap 30, a screw holder 40, and a screw 44. The binding strap 30 has a through hole 31 in one end, namely, the lead end thereof, two retaining holes 34 in the lead end at two opposite lateral sides of the through hole 31, and two lugs 35 respectively protruded from the top and bottom sides of the lead end in reversed directions. The screw holder 40 comprises two clamping plates 41 respectively clamped on the back sidewall of the lead end of the binding strap 30. The clamping plates 41 each have a retaining hole 43 forced into engagement with one lug 35 of the binding strap 30, and two protruded engagement portions 42 respectively forced into engagement with the retaining holes 34 of the binding strap 30. The screw 44 mounted in the screw hole 40 and meshed with the transversely grooved tail end of the binding strap 30, and rotated to fasten tight the binding strap 30 so as to secure on one end of a hose (not shown) to one end of a hard tube (not shown).

The main features of the present invention are outlined hereinafter with reference to FIGS. 4˜6 again. The binding strap 30 has two recessed holes 36 respectively disposed in the front (outer) sidewall of the lead end at different elevations adjacent to the lugs 35, two protruded portions 37 respectively protruded from the back (inner) sidewall of the lead end corresponding to the recessed holes 36. When clamping the clamping plates 41 of the screw holder 40 on the back sidewall of the lead end of the binding strap 30, the lugs 35 of the binding strap 30 are respectively inserted through the retaining holes 43 of the clamping plates 41 and forced into engagement with the outside walls of the clamping plates 41, and at the same time the protruded portions 37 are respectively engaged into the retaining holes 43 to secure the clamping plates 41 of the screw hole 40 in position, preventing the clamping plates 41 from vertical movement relative to the lead end of the binding strap 30. Further, the lead end of the binding strap 30 has a curved body portion 32 within which the through hole 31, the lugs 35, the recessed holes 36, and the protruded portions 37 are provided, and two vertical stop portions 33 at two ends of the curved body portion 32. The retaining holes 34 cut through the vertical stop portions 33. The width of the curved body portion 32, i.e., the distance between the vertical stop portions 33 is equal to the width of the clamping plates 41 of the screw holder 40. When clamping the clamping plates 41 on the back sidewall of the lead end of the binding strap 30, the clamping plates 41 are stopped between the vertical stop portions 33 and prohibited from horizontal movement relative to the lead end of the binding strap 30.

As indicated above, the tube clamp achieves the following advantages.

1. After installation of the screw holder 40 in the lead end of the binding strap 30, the vertical stop portions 33 of the binding strap 30 stop the clamping plates 41 of the screw holder 40 from horizontal displacement relative to the binding strap 30.

2. After engagement of the protruded portions 37 of the binding strap 30 into the retaining holes 43 of the screw holder 40, the protruded portions 37 prohibit the clamping plates 41 from vertical movement relative to the lead end of the binding strap 30.

3. When the screw holder 40 fastened to the lead end of the binding strap 30, the protruded engagement portions 42 of the screw holder 40 respectively engage the retaining holes 34 of the binding strap 30, preventing movement of the screw holder 40 relative to the binding strap 30.

4. Because the lugs 35 are respectively inserted through the through holes 43 of the clamping plates 41 and clamped on the outside wall of the screw holder 40 and because the protruded engagement portions 42 of the screw holder 40 are respectively engaged into the retaining holes 34 of the binding strap 30, rotating the screw 44 to fasten up the tube clamp does not force the clamping plates 41 outwards from the lead end of the binding strap 30.

5. The curved body portion 32 and vertical stop portions 33 of the binding strap 30 define a space to receive the protruded engagement portions 42 of the screw holder 40 when the protruded engagement portions 42 engaged into the retaining holes 34 of the binding strap 30, the screw 44 can smoothly be rotated to pull the transversely grooved tail end of the binding strap 30 over the lead end of the binding strap 30 with less effort.

A prototype of tube clamp has been constructed with the features of FIGS. 4˜6. The tube clamp functions smoothly to provide all of the features discussed earlier.

Although a particular embodiment of the invention has been described in detail for purposes of illustrations various modifications and enhancements may be made without departing from the spirit and scope of the invention. Accordingly, the invention is not to be limited except as by the appended claims.

What the invention claimed is:

1. A tube clamp comprising:
a binding strap adapted to be wound round the connection area of two tubular members being inserted one into the other, said binding strap comprising a lead end, a tail end end, a through hole in said lead end, two retaining holes in said lead end at two opposite lateral sides of said through hole, and two lugs respectively protruded from top and bottom sides of said lead end in reversed directions;
a screw holder fastened to the lead end of said binding strap to join the lead end and tail end of said binding strap, said screw holder comprising two clamping plates respectively clamped on the lead end of said binding strap, said clamping plates each having a retaining hole forced into engagement with one lug of said binding strap, and two protruded engagement portions respectively engaged into the retaining holes of said binding strap; and
a screw mounted in said screw holder and meshed with the transversely grooved tail end of said binding strap for rotation by hand to move the transversely grooved tail end of said binding strap relative to the lead end of said binding strap;
wherein said binding strap has two recessed holes respectively disposed in a front sidewall of said lead end at different elevations adjacent to said lugs, and two protruded portions respectively protruded from a back sidewall of said lead end corresponding to said recessed holes and engaged into the retaining holes of the clamping plates of said screw holder.

2. The tube clamp as claimed in claim 1 wherein said binding strap has a curved body portion formed in said lead end within which the through hole, lugs, recessed holes, and protruded portions of said binding strap are provided, and two vertical stop portions disposed at two ends of said curved body portion and respectively stopped against the clamping plates of said screw holder at two sides, said retaining holes of said binding strap cut through said vertical stop portions.
